(19) United States
(12) Patent Application Publication
(10) Pub. No.: US 2003/0174489 A1
(43) Pub. Date: Sep. 18, 2003

(54) Lamp with variation of light ray

(76) Inventor: Kevin Lee, Taipei (TW)

Correspondence Address: LIPAN INDUSTRIAL CO., LTD., P.O. Box No. 6-57, Chung-Ho City, Taipei, 235, TW

(21) Appl. No.: 10/098,364

(22) Filed: Mar. 18, 2002

(51) Int. Cl. F21V 7/00

(52) U.S. Cl. 362/1

(57) ABSTRACT

A lamp with variation of light ray mainly has at least an additional enclosed, separated, transparent and isolated space disposed within an enclosed and transparent case; within the said transparent case and the isolated space, liquid of different colors is respectively accommodated; a plurality of floats of different properties are dispersed in the liquid inside each separated space; the bottom side of the transparent case is disposed with a base body to house a light heating source to be used for projecting light ray into and heating the transparent case, thereby making the liquid inside each separated space convect; the floats thereof display blinking effect of kinetic light permeation or reflection to form a visual presentation of different colors and motions.

### BACKGROUND OF THE INVENTION

1) Field of the Invention

The present invention relates to a lamp with variation of light ray, more especially, to a structure using a light source to generate light and heat to make a plurality of separated liquid of different colors enclosed in a transparent container convect and expand for producing variation to form kinetic and visual aesthetic of light ray and colors.

2) Description of the Prior Art

Along with the industrial and business prosperity, various decorative lighting accessories for living environment have thus become indispensable items to meet people's enhanced living standard; however, generally, the conventional lighting accessories for decorative purposes vary in styles; the most familiar ones have simple and transparent containers holding colored and transparent liquid with a plurality of fine, freely flowing and light-reflecting floats dispersed therein; a light source is disposed on the side of the said transparent container; the heat generated by the light source is used to make the liquid inside the transparent container convect and further make the floats therein flow; in addition, the said floats are capable of reflecting lamp light towards different directions to form a visual effect of variations of kinetic and blinking light ray.

There is another kind of lighting tool holding two kinds of liquid of different specific gravities, colors and insoluble in one another within the said transparent container; a light heating source is used to project light ray into and heat the container; different convection states are formed through these two kinds of liquid of different specific gravities; the differences and variations of the convention states are presented by colors to form another kind of special visual effect.

However, in the modem society filled with intense competitions, the life cycles of various merchandises have been shortened and the unique features thereof has to be more specific, otherwise, they might be eliminated from the market due to insufficient competitive capacity; therefore, how to design a special light accessory to meet the consumer's demand has become an issue for the industrials to strive for success.

In view of the mentioned reasons, the inventor of the present invention addressed the abovementioned shortcomings, researched for improvement and finally developed the present invention of a lamp with variation of light ray.

### SUMMARY OF THE INVENTION

The primary objective of the present invention aiming to provide a lamp with variation of light ray mainly has at least one additional enclosed, separated, transparent and isolated space disposed within an enclosed and transparent case; within the said transparent case and the isolated space, liquid of different colors is respectively accommodated; a plurality of floats of different properties are dispersed in the liquid inside each separated space; the bottom side of the transparent case is disposed with a base body to house a light heating source to be used for projecting light ray into and heating the transparent case, thereby making the liquid inside each separated space convect; the floats thereof display blinking effect of kinetic light permeation and reflection to form a visual presentation of different colors and motions.

The present invention of a lamp with variation of light ray, wherein each transparent and isolated space inside the transparent case is partitioned and enclosed layer by layer to have a plurality of layers of differently colored liquid, thereby to achieve the visual effect of different colored light permeation.

To enable a further understanding of the objectives, features and effects of the present invention, the brief description of the drawings below is followed by the detailed description of the preferred embodiment.

### BRIEF DESCRIPTION OF THE DRAWINGS

FIG. 1 is a pictorial and exploded drawing of the present invention.

FIG. 2 is a schematic drawing of the assembled present invention.

FIG. 3 is a cross-sectional drawing of the assembled present invention.

FIG. 4 is a drawing of another preferred exemplary embodiment of the present invention.

### DETAILED DESCRIPTION OF THE PREFERRED EMBODIMENTS

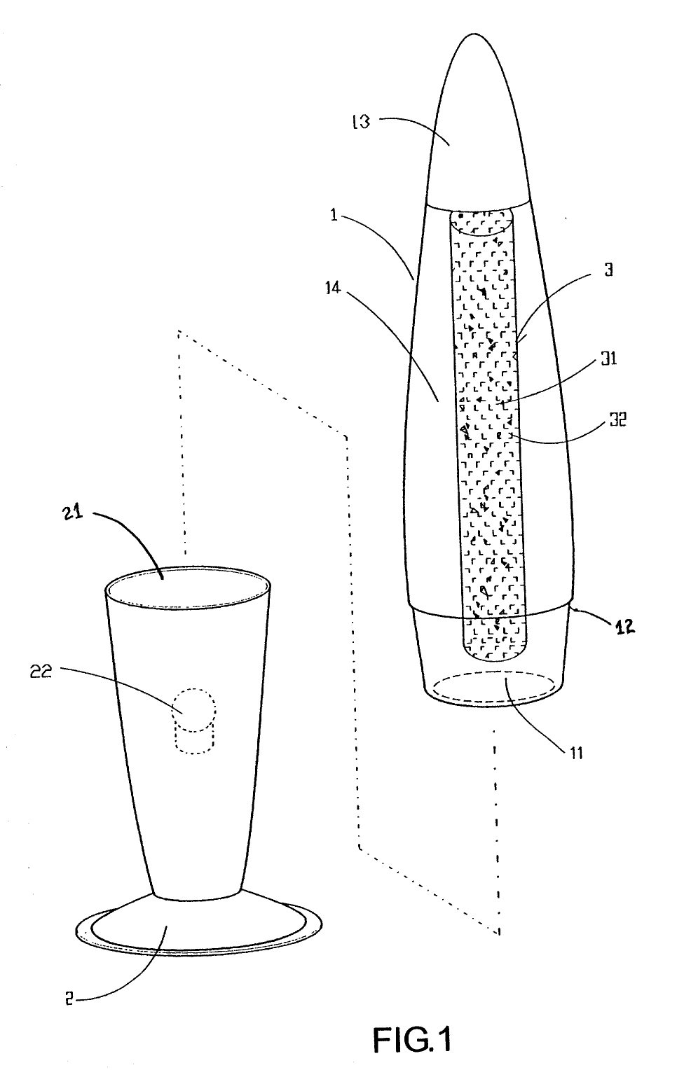

Referring to FIG. 1, as indicated in the pictorial and exploded drawing of the present invention, the present invention mainly comprises a transparent case (1), a base body (2) and an isolated space (3); wherein the transparent case (1) is an enclosed space with a concave portion (11) disposed at the center at the bottom end thereof; after the first liquid (14) is poured in through an opening disposed at the top end, a decorative lid (13) is covered on the opening for sealing; an annular flange (12) is circled around the middle section of the transparent case (1); the base body (2) is disposed on the bottom side of the transparent case (1) and has an opening portion (21) on the top side; a light beating source (22) is disposed inside the opening portion (21); the isolated space (3) is disposed inside the transparent case (1) with one end portion thereof disposed at the upper aspect of the inward concave of the said concave portion (11); a second liquid (31) with color different from that of the first liquid (14) is accommodated in the isolated space (3); a plurality of light-reflecting and fine second floats (32), such as thin, small and glistering metal flakes, are dispersed inside the second liquid (31).

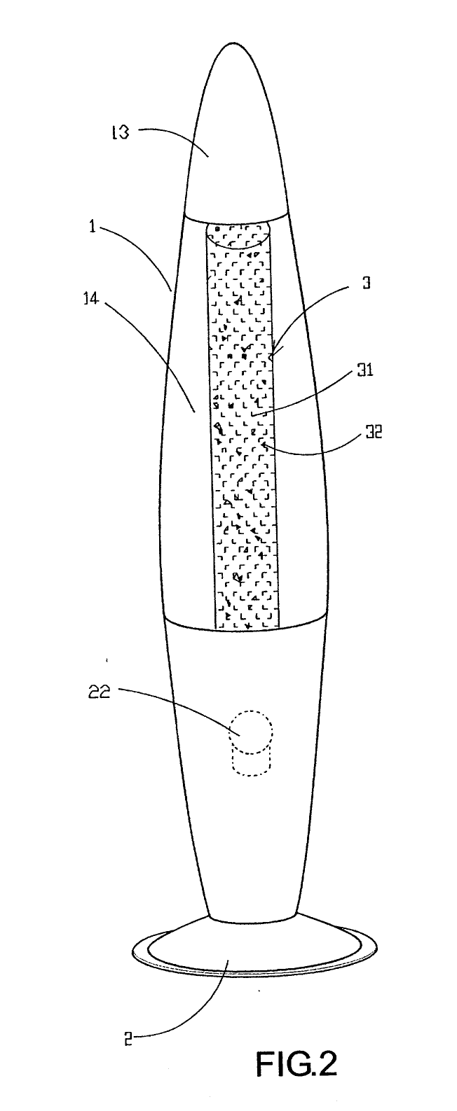

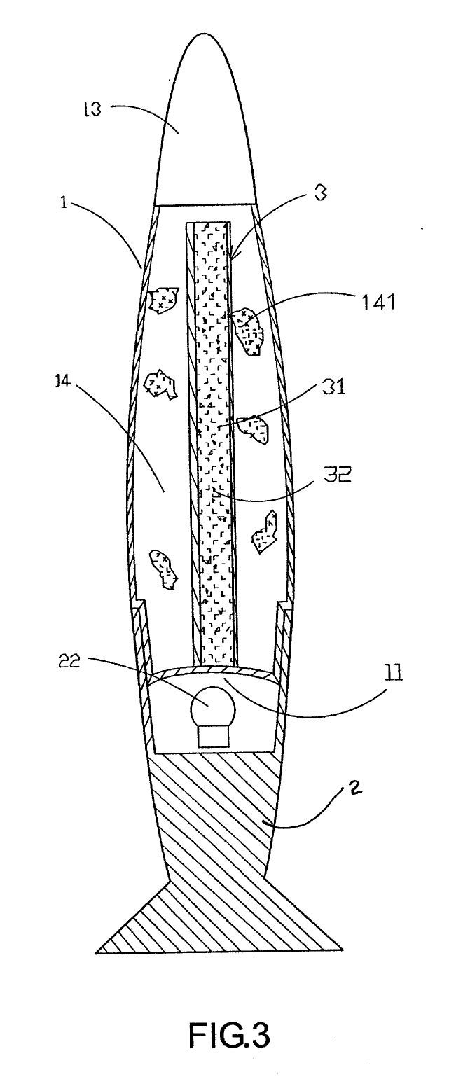

Referring to FIGS. 2 and 3, the schematic drawing and the cross-sectional drawings of the assembled present invention, during assembling, one end portion of the concave portion (11) of the transparent case (1) is inserted into the opening portion (21) of the base body (2); through the holding of the annular flange (12), the transparent case (1) is positioned on the peripheral rim of the opening portion (21) of the base body (2); at the same time, the concave potion (11) is fitly inserted onto the upper aspect and the peripheral rim of the light heating source (22); after the light heating source (22) inside the base body (2) is electrically communicated, the light ray is projected into the transparent case (1); the heat generated by the said light heating source (22) heats the first liquid (14) inside the transparent case (1) and the second liquid (31) inside the isolated space (3) to convect respectively and produce vivid and kinetic effect of variations of moving colors therein; the second floats (32) inside the isolated space (3) also start to flow and reflect light ray from different directions and positions to create blinking visual effect; first floats (141) such as floatable wax, with floating properties different from the second floats (32) is dispersed in the transparent case (1) according to the need to float along with the heated and convecting first liquid (14); the translucent first floats (141) makes kinetic variations of dark or light colors inside the transparent case (1).

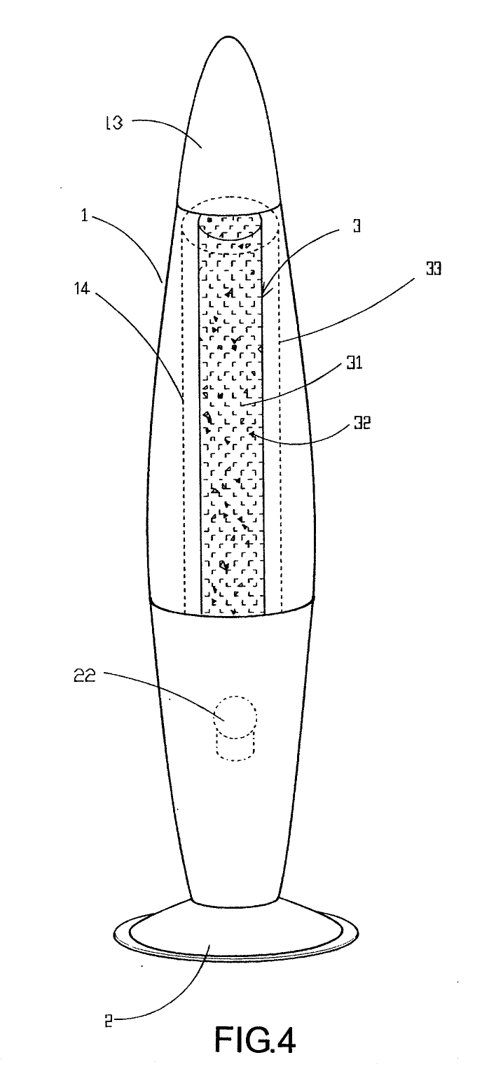

Referring to FIG. 4, the drawing of another preferred exemplary embodiment of the present invention, as indicated, at least an additional middle partition case (33) is disposed between the isolated space (9) and the transparent case (1); the middle partition case (33) is a transparent case body with an interior space capable of accommodating a colored liquid different from the first and the second liquid (14, 31); therefore, a plurality of enclosed layers are formed inside the transparent case (1) to produce a kinetic variation effect of light ray of more colors and layers.

It is obvious from the abovementioned that the present invention of a lamp with variation of light ray specifically comprises a plurality of layers of liquid of different colors, is capable of reflecting different light ray and achieving visual effect of kinetic variation.

It is of course to be understood that the embodiment described herein of the not yet previously and publicly disclosed present invention is merely illustrative of the principles of the invention and that a wide variety of modifications thereto may be effected by persons skilled in the art without departing from the spirit and scope of the invention as set forth in the following claims.

1. A lamp with variation of light ray comprises at least:
a transparent case to be formed into an enclosed space accommodated with first floats;
a base body disposed at a proper position on the bottom side of the said transparent case and with a light heating source housed therein;
an isolated space disposed inside the said transparent case with the bottom portion thereof jointed with the said transparent case and having a main container therein for accommodating colored second floats;
after the light heating source is electrically communicated, light ray is projected into the said transparent case and heated to make the liquid inside the said transparent case and the isolated space convect to form variable and kinetic changes of light ray and colors.

2. A lamp with variation of light ray according to claim 1, wherein the isolated space is enclosed by a plurality of middle partition cases.

3. A lamp with variation of light ray according to claim 1, wherein a plurality of floats are dispersed in the first and the second liquid.

4. A lamp with variation of light ray according to claim 3, wherein the floats are wax bodies.

5. A lamp with variation of light ray according to claim 3, wherein the floats are glistering flakes.

6. A lamp with variation of light ray according to claims 1, wherein a concave portion concaved inwardly is disposed at the bottom end of the said transparent case.

7. A lamp with variation of light ray according to claims 1, wherein a decorative lid is disposed at the top end of the said transparent case.
